(19) United States
(12) Patent Application Publication
(10) Pub. No.: US 2009/0253287 A1
(43) Pub. Date: Oct. 8, 2009

(54) Electrical connector with LGA contacts

(75) Inventors: Igor Polnyi, Aurora, IL (US); Jia-Hau Liu, Tu-cheng (TW); Fang-Chu Liao, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/080,467

(22) Filed: Apr. 3, 2008

(51) Int. Cl. H01R 13/62

(52) U.S. Cl. 439/331

(57) ABSTRACT

A contact, adapted for electrically connecting IC package and a printed circuit board, comprises a base, an upper spring arm and a lower spring arm. The upper spring arm is formed with an upper waist portion extending from a top edge of the base and a top end for electrically contacting with the IC package; and the lower spring arm is formed with a lower waist portion extending from a bottom edge of the base and a bottom end for electrically contacting with the printed circuit board. The bottom end has a width larger than that of the top end, and the lower waist portion has a width larger than that of the upper waist and defines a slot in a middle thereof.

### BACKGROUND OF THE INVENTION

1. Field of the Invention

The present invention relates to the art of electrical connectors, and more particularly to a land grid array (LGA) contact of an electrical connector.

2. Description of the Related Art

Various types of connectors have been developed for electrical connections between an IC package and a printed circuit board, such as Pin Grid Array (PGA) connectors, Ball Grid Array (BGA) connectors, Land Grid Array (LGA) connectors, etc., which are named by conductive elements of the IC packages that the connectors electrically connect. Contacts resided within the respective connectors are accordingly classified as PGA contacts, BGA contacts, LGA contacts and so on.

U.S. Pat. No. 7,189,080 discloses an electrical connector with LGA contacts. The LGA contact includes a base with a retaining portion, and a pair of spring arms extending from a top and a bottom sides of the base. Each of the spring arms includes a contacting section at a free end thereof, adapted for electrically contacting an IC package and a printed circuit board, respectively. The contacting section is split into dual-structure contact regions. The contact is approximately symmetrical in an up and down direction, so the contact can give equal forces on the IC package and the printed circuit board, respectively. However, contact pitch in such electrical connector becomes more and more smaller, correspondingly, pads on the IC package may change to smaller size, and simultaneity, a size of the pad on the printed circuit board may not change. At this time, the contact disclosed in U.S. Pat. No. 7,189,080 may not be advisable.

Accordingly, a new contact that solves the above problems is desirable.

### SUMMARY OF THE INVENTION

A contact, adapted for electrically connecting an IC package and a printed circuit board, comprises: a base, being a board-like shape; an upper spring arm being formed with an upper waist portion extending from a top edge of the base and a top end for electrically contacting with the IC package; and a lower spring arm being formed with a lower waist portion extending from a bottom edge of the base and a bottom end for electrically contacting with the printed circuit board, the bottom end having a width larger than that of the top end, and the lower waist portion having a width larger than that of the upper waist and defining a slot in a middle thereof.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is a perspective view of a contact according to a preferred embodiment of the present invention;

FIG. 2 is a front view of the contact of FIG. 1;

FIG. 3 is a top view of the contact of FIG. 1; and

FIG. 4 is a side view of the contact of FIG. 1.

### DETAILED DESCRIPTION OF PREFERRED EMBODIMENT

Reference is now made to the drawings to describe the invention in detail.

Present invention substantially regard to improved LGA contacts used in an electrical connector (not shown) with which further comprises an insulative housing (not shown). The insulative housing (not shown) defines a plurality of passageways (not shown) for receiving the LGA contacts which approximately has same configure with conventional insulative housing used in such electrical connector, so herein after we will not give further detail descriptions about the insulative housing (not shown).

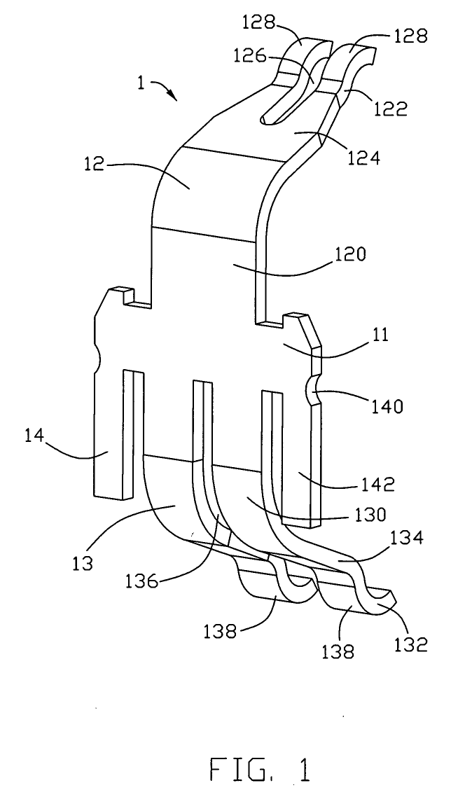

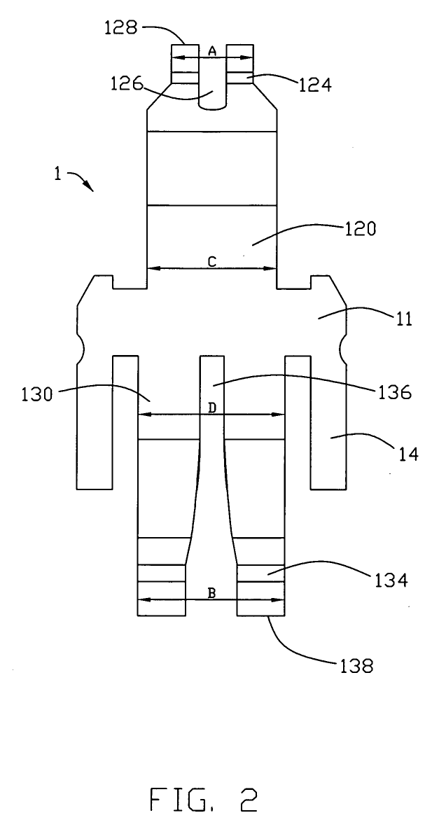

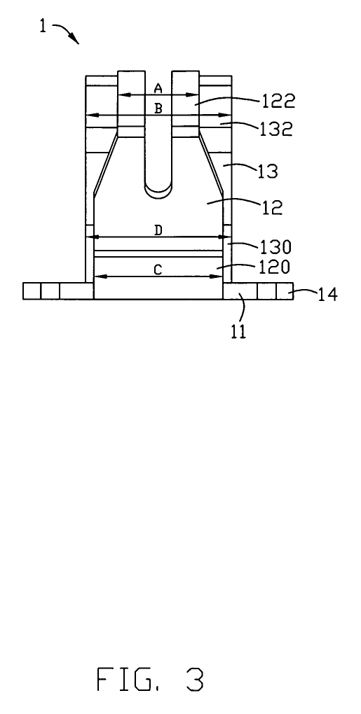

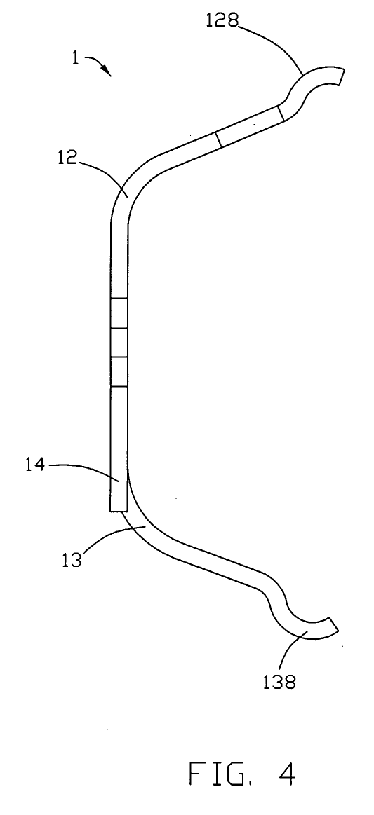

Referring to FIGS. 1 to 4, an LGA contact 1 according to the preferred embodiment of the present invention is stamped from a metal piece, the contact 10 includes a base 11, an upper spring arm 12, a lower spring arm 13, and a pair of retaining portions 14.

The base 11 of the contact 1 is in a rectangle piece-shape, the upper spring arm 12 stretches from a top edge of the base 11, the lower spring arm 13 stretches from a bottom edge of the base 11, and the retaining portions 14 downwardly stretch from two lateral ends of the base 11. The contact 1 is approximately in a U-shape, taken from a lateral side.

The upper spring arm 12 comprises an upper waist portion 120 connecting with the base 11, a top end 122 and an inclined linking portion 124 linking the upper waist portion 120 and the top end 122. The upper waist portion 120 firstly upright and then Obliquely extends from the top edge of the base 11. The upper spring arm 12 further defines a gap 126 downwardly extending from a middle part of a top edge thereof and passing through the top end 122 and a part of the linking portion 124. The gap 126 divides the top end 122 into dual contacting regions 128 besides the gap 126. The two contacting regions 128 are approximately in an arc configure and used for electrically contacting with the same pad (not shown) of an IC package (not shown), so that the contact 1 can reliably electrically connect with the IC package (not shown).

The lower spring arm 13 comprises a lower waist portion 130 connecting with the base 11, a bottom end 132 and a linking portion 134 linking the lower waist portion 130 and the bottom end 132. The lower waist portion 130 firstly upright and then Obliquely extends from the bottom edge of the base 11. The lower spring arm 13 defines a through slot 136 to separate the lower spring arm 13 into two branches with same configure and form two contacting regions 138 on the bottom end 132. The two contacting regions 138 are used for electrically contacting with the same pad (not shown) of a printed circuit board (not shown), so that the contact 1 can reliably electrically connect with the printed circuit board (not shown).

The two retaining portions 14 are provided on two lateral sides of the base 11, the retaining portion 14 has an arc nick 140 on an out side surface thereof and an engaging portion 142 vertically and downwardly extending for being interferingly retained in the insulative housing (not shown) of the electrical connector (not shown).

Since the pad of the IC package (not shown) is small relative to the pad of the printed circuit board (not shown), so a width A of the top end 122 of the upper spring arm 12 is smaller than a width B of the low end 132 of the lower spring arm 13 to prevent the contacting regions 128 of the upper spring arm 12 from sliding out of an area of the pad of the IC package (not shown). So, a spring constant of the top end is small, to improve this point, the upper spring arm 12 is approximately formed in one-piece shape with an integral waist portion 122. However, the lower spring arm 13 is divided into two-piece shape by the through slot 136 in a middle thereof, this configure with the gap 136 reduces a whole spring constant of the lower spring arm 13. For avoiding the spring constant of lower spring arm 13 smaller than that of the upper spring arm 12, a width D of the lower waist portion 132 is disposed larger than a width C of the upper waist portion 122 to increase the spring constant of the lower spring arm 13. By this manner, the upper spring arm 12 and the lower spring arm 13 obtain the same spring constants. When the contact 1 Synchronously contacts with the IC package (not shown) and the printed circuit board (not shown) from a top and a bottom sides, the contacts 1 will be pressed, for the upper spring arm 12 and the lower spring arm 13 has same spring constants, the upper spring arm 12 and the lower spring arm 13 produce equal forces on the IC package (not shown) and the printed circuit board (not shown), respectively, so the contact 1 will be balanced during this process.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

1. A contact, adapted for electrically connecting an IC package and a printed circuit board, comprising:
a base, being a board-like shape;
an upper spring arm being formed with an upper waist portion extending upwardly from a top edge of the base and a top end for electrically contacting with the IC package; and
a lower spring arm being formed with a lower waist portion extending downwardly from a bottom edge of the base and a bottom end for electrically contacting with the printed circuit board, the bottom end having a width larger than that of the top end, and the lower waist portion having a width larger than that of the upper waist and defining a slot in a middle thereof; wherein
the slot passes through the lower spring arm to separate the lower string arm into two branches and form two contacting regions on the lower end, and the upper string arm provides a substantially equal elasticity of that of the upper spring arm.

2. (canceled)

3. The contact of claim 1, wherein the upper spring arm defines a gap on the top end thereof to divide the top end into another two contacting regions besides the gap, but the gap does not extend on the upper waist portion.

4. The contact of claim 3, wherein the upper waist portion and the lower waist portion firstly vertically and then aslant extend from the base, respectively, the contact is a U-shape taken from a lateral side.

5. The contact of claim 3, wherein the contact has two inclined linking portions connecting the upper waist portion with the top end and the lower waist portion with the lower end, respectively.

6. The contact of claim 3, wherein the contact has two retaining portions on two lateral sides of the base, the retaining portion has an engaging portion vertically and downwardly extending far being interferingly retained in an insulative housing of an LGA connector.

7. An electrical connector, adapted for electrically connecting an IC package and a printed circuit board, comprising:
an insulative housing; and
a contact received in the insulative housing, the contact has a base, an upper spring arm and a lower spring arm, the upper spring arm being formed with an upper waist portion extending from a top edge of the base and a top end adapted for contacting the IC package, the lower spring arm being formed with a lower waist portion extending from a bottom edge of the base and a bottom end adapted for contacting the printed circuit board, and the lower waist portion having a through slot extending along a center line thereof to reduce a spring constant of the lower spring arm, while the upper waist portion is a one-piece configure; wherein
the top end is located above the bottom end in a vertical direction.

8. The electrical connector of claim 7, wherein the bottom end has a width larger than that of the top end, and the lower waist portion has a width larger than that of the upper waist.

9. The electrical connector of claim 8, wherein the slot passes through the lower spring arm to separate the lower spring arm into two branches and form two contacting regions on the lower end.

10. The electrical connector of claim 9, wherein the upper spring arm defines a gap on the top end thereof to divide the top end into another two contacting regions besides the gap, but the gap does not arrive the upper waist portion.

11. The electrical connector of claim 10, wherein the upper waist portion and the lower waist portion firstly vertically and then aslant extend from the base, respectively, the contact is a U-shape taken from a lateral side

12. The electrical connector of claim 10, wherein the contact has two retaining portions on two lateral sides of the base, the retaining portion has an engaging portion vertically and downwardly extending from the base to engage with the insulative housing.

13. An electrical contact comprising:
a base portion, being rectangular shape;
two retaining portions extending from two opposite sides of the base portion and forming a U-shaped configuration cooperated with the base portion;
a first resilient arm extending from an elongated edge of said bridge in a first vertical direction and also in a first oblique direction, said first resilient arm essentially defining a first vertical section linked to the base portion and a first inclined linking portion;
a second resilient arm extending from the other elongated edge of the bridge in a second vertical direction opposite to said first vertical direction, and also in a second oblique direction, said second resilient arm essentially defining a second vertical section linked to the base portion and a second inclined linking portion, wherein
the first resilient arm defines a first slot extending along both the first vertical section and the first inclined linking portion while the second resilient arm defines a second slot extending along only the second oblique direction under a condition that the first resilient arm is wider than the second resilient arm.

14. The contact as claimed in claim 13, wherein the first resilient arm has a constant width while the second resilient arm has a smaller width at a free end region in comparison with remainder.

15. The contact as claimed in claim 13, wherein the side arms and the first resilient arm are located on a same side with regard to the bridge while the second resilient arm is located on an opposite side.
